(19) United States
(12) Patent Application Publication
(10) Pub. No.: US 2025/0173389 A1
(43) Pub. Date: May 29, 2025

(54) METHOD AND SYSTEM FOR PRE-PROCESSING DATA FOR ALGORITHMIC FAIRNESS VIA OPTIMAL TRANSPORT

(71) Applicant: JPMorgan Chase Bank, N.A., New York, NY (US)

(72) Inventors: Niccolo DALMASSO, Long Island City, NY (US); Zikai XIONG, Cambridge, MA (US); Alan MISHLER, Pittsburgh, PA (US); Vamsi Krishna POTLURU, New York, NY (US); Tucker Richard BALCH, Suwanee, GA (US); Manuela VELOSO, New York, NY (US)

(73) Assignee: JPMorgan Chase Bank, N.A., New York, NY (US)

(21) Appl. No.: 18/521,243

(22) Filed: Nov. 28, 2023

(51) Int. Cl. G06F 17/11

(52) U.S. Cl. CPC G06F 17/11

(57) ABSTRACT

A method and a system for pre-processing data for algorithmic fairness via optimal transport in order to reduce disparities in classification datasets without modifying the original data are provided. The method includes: receiving a first dataset that includes a set of samples, each respective sample including a first coordinate that relates to sensitive demographic features, a second coordinate that relates to decision-making features, and a third coordinate that relates to a decision outcome that is generated by a machine learning model; determining a demographic parity constraint to be applied to the first dataset; computing a set of respective sample-level weights that correspond to each sample; and generating a second dataset by applying the set of respective sample-level weights to the first dataset The computation of the sample-level weights includes minimizing a Wasserstein distance between the first dataset and a weighted version thereof while satisfying the demographic parity constraint.

### BACKGROUND

### 1. Field of the Disclosure

This technology generally relates to methods and systems for pre-processing data to be used as training data for a machine learning model, and more particularly to methods and systems for pre-processing data for algorithmic fairness via optimal transport in order to reduce disparities in classification datasets without modifying the original data.

### 2. Background Information

Machine learning is increasingly involved in decision making that impacts people's lives. There is concern that models may inherit from the data bias against subgroups defined by race, gender, or other protected characteristics. Accordingly, there is a vast literature on methods to make machine learning models “fair”. While there is no consensus about what it means for a model to be fair or unfair in a given setting, these methods commonly aim to minimize disparities in model outputs or model performance across different subgroups.

Fair machine learning methods are traditionally divided into three categories: 1) Pre-processing methods intervene on the training data; 2) in-processing methods apply constraints or regularizers during the model training process itself; and 3) post-processing methods alter the outputs of previously trained models.

Among these three, no one category of methods clearly dominates the other in terms of performance. Pre-processing methods are useful when the person who generates or maintains a dataset is not the same as the person who will be using it to train a model, or when a dataset may be used to train multiple models. These methods typically require no knowledge of downstream models, so in principle they are compatible with any subsequent machine learning procedure.

Many pre-processing methods operate by changing the feature values or labels of the training data, subsampling or oversampling the data, and/or generating synthetic data. In high-stakes settings such as finance and healthcare, however, it may be unethical or even illegal to alter customer or patient attributes or labels. Maintaining separate synthetic or modified versions of datasets is possible but may be costly for large datasets. An alternative is to learn a set of sample weights that can be passed to a learning method at training time. While there are many methods that do this, they focus on satisfying fairness constraints without providing guarantees about how much they alter the overall distribution of the data.

Accordingly, there is a need for a method for pre-processing data for algorithmic fairness via optimal transport in order to reduce disparities in classification datasets without modifying the original data.

### SUMMARY

The present disclosure, through one or more of its various aspects, embodiments, and/or specific features or sub-components, provides, inter alia, various systems, servers, devices, methods, media, programs, and platforms for methods and systems for pre-processing data for algorithmic fairness via optimal transport in order to reduce disparities in classification datasets without modifying the original data.

According to an aspect of the present disclosure, a method for pre-processing data for algorithmic fairness via optimal transport in order to reduce disparities in classification datasets without modifying the original data is provided. The method is implemented by at least one processor. The method includes: receiving, by the at least one processor, a first dataset that includes a plurality of samples, each respective sample including a first coordinate that relates to sensitive demographic features, a second coordinate that relates to decision-making features, and a third coordinate that relates to a decision outcome that is generated by a machine learning model; determining, by the at least one processor, a demographic parity constraint to be applied to the first dataset; computing, by the at least one processor, a set of respective sample-level weights that correspond to each sample included in the plurality of samples, each respective sample-level weight being a positive integer; and generating, by the at least one processor, a second dataset by applying the set of respective sample-level weights to the first dataset. The computing of the set of respective sample level weights includes minimizing, by the at least one processor, a Wasserstein distance between the first dataset and a weighted version of the first dataset while satisfying the demographic parity constraint.

The method may further include reformulating the minimizing of the Wasserstein distance as a mixed-integer program (MIP).

The method may further include generating a linear program (LP) relaxation of the MIP.

The method may further include generating a dual problem that corresponds to the LP relaxation.

The method may further include solving the dual problem by using a cutting plane method.

The method may further include using a result of the solving of the dual problem to extend the minimizing of the Wasserstein distance to account for a group-wise demographic parity.

The machine learning model may be configured to use an artificial intelligence technique for making a decision based on input data that relates to a person, and wherein the decision relates to at least one from among a consumer finance question, a health insurance question, and a hiring question.

The sensitive demographic features may include at least one from among race, gender, national origin, and disability.

The decision-making features may include at least one from among a level of education, a grade point average (GPA), and a level of income.

According to another exemplary embodiment, a computing apparatus for pre-processing data for algorithmic fairness to reduce disparities in classification datasets without modifying the original data is provided. The computing apparatus includes a processor; a memory; and a communication interface coupled to each of the processor and the memory. The processor is configured to: receive, via the communication interface, a first dataset that includes a plurality of samples, each respective sample including a first coordinate that relates to sensitive demographic features, a second coordinate that relates to decision-making features, and a third coordinate that relates to a decision outcome that is generated by a machine learning model; determine a demographic parity constraint to be applied to the first dataset; compute a set of respective sample-level weights that correspond to each sample included in the plurality of samples, each respective sample-level weight being a positive integer; and generate a second dataset by applying the set of respective sample-level weights to the first dataset. The computation of the set of respective sample-level weights includes minimizing a Wasserstein distance between the first dataset and a weighted version of the first dataset while satisfying the demographic parity constraint.

The processor may be further configured to reformulate the minimization of the Wasserstein distance as an MIP.

The processor may be further configured to generate an LP relaxation of the MIP.

The processor may be further configured to generate a dual problem that corresponds to the LP relaxation.

The processor may be further configured to solve the dual problem by using a cutting plane method.

The processor may be further configured to use a result of the solving of the dual problem to extend the minimization of the Wasserstein distance to account for a group-wise demographic parity.

The machine learning model may be configured to use an artificial intelligence technique for making a decision based on input data that relates to a person, and wherein the decision relates to at least one from among a consumer finance question, a health insurance question, and a hiring question.

The sensitive demographic features may include at least one from among race, gender, national origin, and disability.

The decision-making features may include at least one from among a level of education, a GPA, and a level of income.

According to yet another exemplary embodiment, a non-transitory computer readable storage medium storing instructions for pre-processing data for algorithmic fairness to reduce disparities in classification datasets without modifying the original data is provided. The storage medium includes executable code which, when executed by a processor, causes the processor to: receive a first dataset that includes a plurality of samples, each respective sample including a first coordinate that relates to sensitive demographic features, a second coordinate that relates to decision-making features, and a third coordinate that relates to a decision outcome that is generated by a machine learning model; determine a demographic parity constraint to be applied to the first dataset; compute a set of respective sample-level weights that correspond to each sample included in the plurality of samples, each respective sample-level weight being a positive integer; and generate a second dataset by applying the set of respective sample-level weights to the first dataset. The computation of the set of respective sample-level weights includes minimizing a Wasserstein distance between the first dataset and a weighted version of the first dataset while satisfying the demographic parity constraint.

When executed, the executable code may further cause the processor to reformulate the minimization of the Wasserstein distance as a MIP.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for pre-processing data for algorithmic fairness via optimal transport in order to reduce disparities in classification datasets without modifying the original data.

FIG. 4 is a flowchart of an exemplary process for implementing a method for pre-processing data for algorithmic fairness via optimal transport in order to reduce disparities in classification datasets without modifying the original data.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

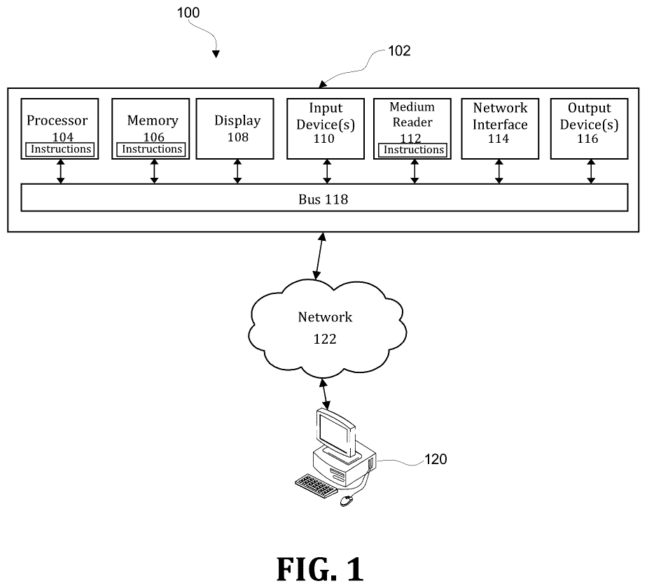

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for pre-processing data for algorithmic fairness via optimal transport in order to reduce disparities in classification datasets without modifying the original data.

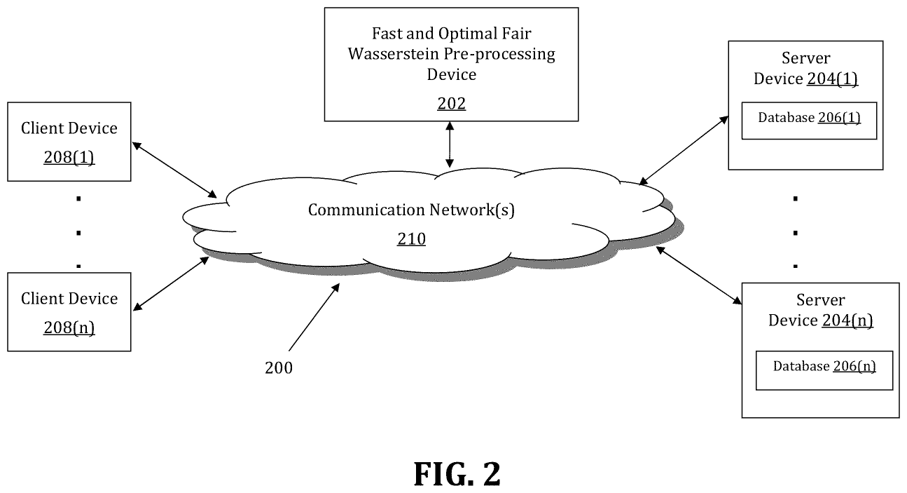

Referring to FIG. 2, a schematic of an exemplary network environment 200 for implementing a method for pre-processing data for algorithmic fairness via optimal transport in order to reduce disparities in classification datasets without modifying the original data is illustrated. In an exemplary embodiment, the method is executable on any networked computer platform, such as, for example, a personal computer (PC).

The method for pre-processing data for algorithmic fairness via optimal transport in order to reduce disparities in classification datasets without modifying the original data may be implemented by a Fast and Optimal Fair Wasserstein Pre-processing (FOFWP) device 202. The FOFWP device 202 may be the same or similar to the computer system 102 as described with respect to FIG. 1. The FOFWP device 202 may store one or more applications that can include executable instructions that, when executed by the FOFWP device 202, cause the FOFWP device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the FOFWP device 202 itself, may be located in virtual server(s) running in a cloud-based computing environment rather than being tied to one or more specific physical network computing devices. Also, the application(s) may be running in one or more virtual machines (VMs) executing on the FOFWP device 202. Additionally, in one or more embodiments of this technology, virtual machine(s) running on the FOFWP device 202 may be managed or supervised by a hypervisor.

In the network environment 200 of FIG. 2, the FOFWP device 202 is coupled to a plurality of server devices 204(1)-204(n) that hosts a plurality of databases 206(1)-206(n), and also to a plurality of client devices 208(1)-208(n) via communication network(s) 210. A communication interface of the FOFWP device 202, such as the network interface 114 of the computer system 102 of FIG. 1, operatively couples and communicates between the FOFWP device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the FOFWP device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and FOFWP devices that efficiently implement a method for pre-processing data for algorithmic fairness via optimal transport in order to reduce disparities in classification datasets without modifying the original data.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The FOFWP device 202 may be a standalone device or integrated with one or more other devices or apparatuses, such as one or more of the server devices 204(1)-204(n), for example. In one particular example, the FOFWP device 202 may include or be hosted by one of the server devices 204(1)-204(n), and other arrangements are also possible. Moreover, one or more of the devices of the FOFWP device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the FOFWP device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store historical information that relates to demographic distributions in various groups and information that relates to metrics for demographic disparity and/or unfairness.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the FOFWP device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the FOFWP device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the FOFWP device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the FOFWP device 202, the server devices 204(1)-204(n), or the client devices 208(1)-208(n), for example, may be configured to operate as virtual instances on the same physical machine. In other words, one or more of the FOFWP device 202, the server devices 204(1)-204(n), or the client devices 208(1)-208(n) may operate on the same physical device rather than as separate devices communicating through communication network(s) 210. Additionally, there may be more or fewer FOFWP devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

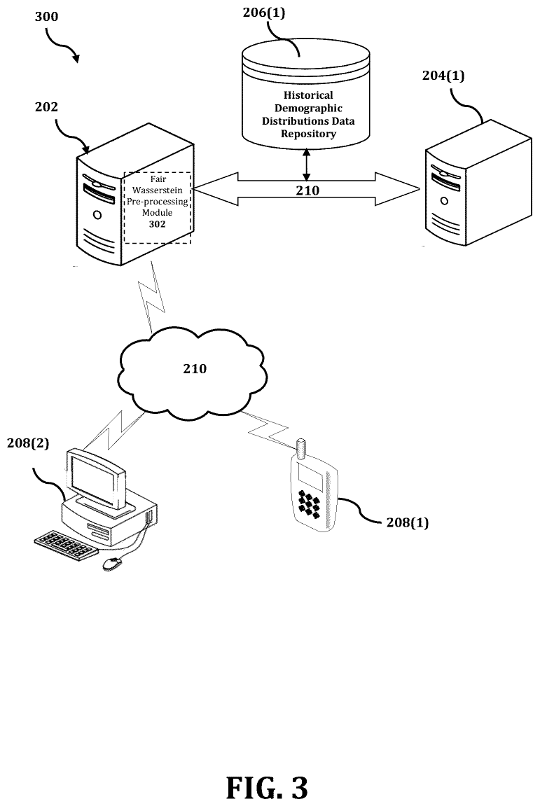

The FOFWP device 202 is described and illustrated in FIG. 3 as including a fair Wasserstein pre-processing module 302, although it may include other rules, policies, modules, databases, or applications, for example. As will be described below, the fair Wasserstein pre-processing module 302 is configured to implement a method for pre-processing data for algorithmic fairness via optimal transport in order to reduce disparities in classification datasets without modifying the original data.

An exemplary process 300 for implementing a mechanism for pre-processing data for algorithmic fairness via optimal transport in order to reduce disparities in classification datasets without modifying the original data by utilizing the network environment of FIG. 2 is illustrated as being executed in FIG. 3. Specifically, a first client device 208(1) and a second client device 208(2) are illustrated as being in communication with FOFWP device 202. In this regard, the first client device 208(1) and the second client device 208(2) may be “clients” of the FOFWP device 202 and are described herein as such. Nevertheless, it is to be known and understood that the first client device 208(1) and/or the second client device 208(2) need not necessarily be “clients” of the FOFWP device 202, or any entity described in association therewith herein. Any additional or alternative relationship may exist between either or both of the first client device 208(1) and the second client device 208(2) and the FOFWP device 202, or no relationship may exist.

Further, FOFWP device 202 is illustrated as being able to access a historical demographic distributions data repository 206(1). The fair Wasserstein pre-processing module 302 may be configured to access this and other databases for implementing a method for pre-processing data for algorithmic fairness via optimal transport in order to reduce disparities in classification datasets without modifying the original data.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the FOFWP device 202 via broadband or cellular communication. Of course, these embodiments are merely exemplary and are not limiting or exhaustive.

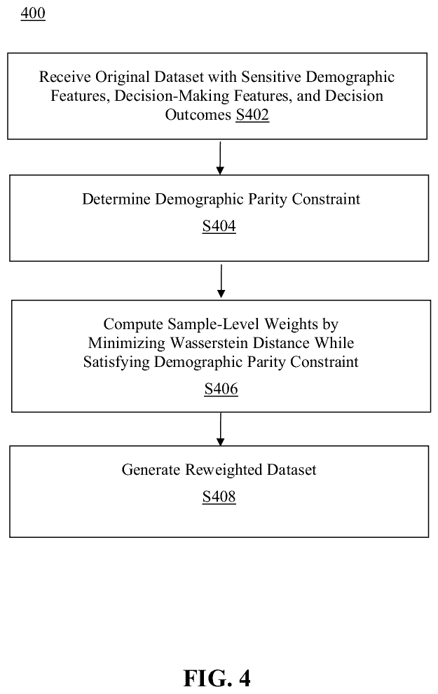

Upon being started, the fair Wasserstein pre-processing module 302 executes a process for pre-processing data for algorithmic fairness via optimal transport in order to reduce disparities in classification datasets without modifying the original data. An exemplary process for pre-processing data for algorithmic fairness via optimal transport in order to reduce disparities in classification datasets without modifying the original data is generally indicated at flowchart 400 in FIG. 4.

In process 400 of FIG. 4, at step S402, the fair Wasserstein pre-processing module 302 receives a first dataset that includes a set of samples. Each sample has at least three coordinates: a first coordinate that relates to sensitive demographic features; a second coordinate that relates to decision-making features; and a third coordinate that relates to a decision outcome that is generated by a machine learning (ML) model. In an exemplary embodiment, the ML model is configured to use an artificial intelligence (AI) technique for making a decision based on input data that relates to a person. The decision may relate to a consumer finance question, a health question, a hiring question, and/or any other type of question that relates to the person.

In an exemplary embodiment, the sensitive demographic features may include any one or more of race, gender, national origin, and disability. In an exemplary embodiment, the decision-making features may include any one or more of a level of education, a grade point average (GPA), and a level of income. In an alternative exemplary embodiment, the sensitive features may not be demographic features, but instead any suitable type of sensitive features.

At step S404, the fair Wasserstein preprocessing module 302 determines a demographic parity constraint to be applied to the first dataset. In an alternative exemplary embodiment, the demographic parity constraint may be a parity constraint that is applicable to a data type that is different from demographic data. Then, at step S406, the fair Wasserstein pre-processing module 302 computes a set of sample-level weights that correspond to each sample included in the set of samples received in step S402. In an exemplary embodiment, each sample-level weight is a positive integer. In an exemplary embodiment, the computation of the set of sample-level weights is performed by minimizing a Wasserstein distance between the first dataset and a weighted version of the first dataset while satisfying the demographic parity constraint. A further description of this operation is provided below.

At step S408, the fair Wasserstein pre-processing module 302 generates a second dataset, i.e., a reweighted dataset, by applying each respective sample-level weight to the corresponding sample from the original dataset (i.e., the first dataset).

In an exemplary embodiment, the minimization of the Wasserstein distance may be implemented by performing the following operations: reformulating the minimization as a mixed-integer program (MIP); generating a linear program (LP) relaxation of the MIP; generating a dual problem that corresponds to the LP relaxation of the MIP; and solving the dual problem by using a cutting plane method. In addition, a result of solving the dual problem may be used to extend the minimization of the Wasserstein distance to account for a group-wise demographic parity. A further description of this implementation is provided below.

In an exemplary embodiment, the FOFWP device 202 and the fair Wasserstein pre-processing module 302 are provided in a system that is referred to herein as “FairWASP”, which is designed to learn a set of sample weights for classification datasets without modifying the training data. FairWASP minimizes the Wasserstein distance between the original and reweighted datasets while ensuring that the reweighted dataset satisfies an empirical version of demographic parity, which is a popular fairness criterion.

FairWASP includes the following features: 1) As directly solving the target optimization problem is computationally infeasible, FairWASP provides a three-step reformulation that leads to a tractable linear program. It is shown that the solution to this linear program is a solution to the original problem under a mild assumption, and further it is shown theoretically that, over the set of real-valued weights, integer-valued weights are optimal. This means that FairWASP can be understood equivalently as indicating which samples (i.e., rows) of the dataset should be duplicated or deleted at training time, so it is compatible with any downstream classification algorithm, not just algorithms that accept sample weights. 2) FairWASP provides a highly efficient algorithm to solve the reformulated linear program. 3) FairWASP is extended to satisfy a separate but equivalent definition of demographic parity by leveraging the linear program reformulation described above. 4) It has been empirically shown that FairWASP achieves competitive performance in reducing disparities while preserving accuracy in downstream classification settings when compared to existing pre-processing methods.

Setup: In an exemplary embodiment, a dataset of n independent and identically distributed (i.e., i.i.d.) samples {Zᵢ=(Dᵢ, Xᵢ, Yᵢ)}ᵢ₌₁ⁿ drawn from a joint distribution p_{Z}=p_{D,X,Y} with domain Z=D×X×Y is considered. In this context, D represents one or more protected variables such as gender or race, X indicates features used for decision-making, and Y is the decision outcome. For example, Yᵢ could represent a loan approval decision for individual i, based on demographic data Dᵢ and credit score Xᵢ. The learning tasks typically aim at learning the conditional distribution P(Y|X) or P(Y|X,D) from the samples {Zᵢ}ᵢ₌₁ⁿ. In an exemplary embodiment, it is assumed that the number of demographic classes |D| and the number of outcome levels |Y| are significantly smaller than n.

Demographic Parity: Demographic parity (DP), also known as statistical parity, requires an outcome variable to be statistically independent of a sensitive feature. This could mean, for example, that an algorithm used to screen resumes for interviews is required to recommend equal proportions of female and male applicants. DP is arguably the most widely studied fairness criterion to date. Violations of DP may be measured in different ways. For FairWASP, in an exemplary embodiment, violations of DP are measured by using the distances between the marginal distribution of an outcome variable and the distributions of that outcome variable conditional on levels of a sensitive feature. Additionally, it may be shown that measuring DP as the distance between outcome distributions for each level of the sensitive feature can also be reformulated in a similar way as the FairWASP optimization problem.

Pre-processing via Reweighting: Conventional approaches have entailed utilizing a set of sample weights based on the sensitive feature and the outcome variable to target demographic parity. However, there have been no guarantees about how the sample weights will change the overall distribution of the data. If the weights alter the distribution of the data significantly, the downstream model might not learn the correct conditional distribution between target variables and features, i.e., P(Y|X) or P(Y|X,D). While minimizing data perturbation has been considered in approaches which seek to learn transformations of the data itself, FairWASP is a reweighting approach that seeks to minimize the overall distributional distance from the original data.

Wasserstein Distance: The general Wasserstein distance, or optimal transport metric, between two probability distributions (μ, ν)∈ [symbol] ₊¹(χ)× [symbol] ₊¹(χ) supported on two metric spaces (X,X) is defined as the optimal objective of the (possibly infinite-dimensional) linear program (LP):

$${𝒲}_{c} ( μ , v ) {=}^{def .} {min}_{π ∈ \prod ( μ , v )} {\int }_{𝒳 \times 𝒳} c ( x , y ) d π ( x , y ) , \qquad ( 1 )$$

where Π(μ,ν) is the set of couplings composed of joint probability distributions over the product space X×X with imposed marginals (μ,ν). Expression (1) is also referred to as the Kantorovitch formulation of optimal transport. Here, c(x,y) represents the “cost” to move a unit of mass from x to y. A typical choice in space X with metric d_{X} is c(x,y)=d_{X}(x,y)^{p} for p≥1, and then W_{c}^{1/p} corresponds to the p-Wasserstein distance between probability measures. Using the Wasserstein distance between distributions is particularly useful, as it provides a bound for functions applied to samples from those distributions. In other words, define the following deviation:

$$d ( μ , v ) {=}^{def .} sup \vert {Ez}_{∼ μ} f ( z ) - {Ez}_{∼ v} f ( z ) \vert , f ∈ F$$

where F is a family of functions ƒ. If F=Lip₁, the class of Lipschitz-continuous functions with Lipschitz constant of 1, the deviation d(μ,ν) is equal to the 1-Wasserstein distance. Analog bounds can be derived for the 2-Wasserstein distance when F={ƒ|∥ƒ∥ₛ_{¹}_{(μ)}≤1}, the class of functions with unitary norm over the Sobolev Space S={ƒ∈L²|∂_{X}_{ᵢ}ƒ∈L²} This fact provides a theoretical intuition for downstream utility preservation, i.e., the closer two distributions in Wasserstein distance, the closer the downstream performance of learning models trained on such distributions is expected to be. Finally, although the Wasserstein distance has been used to express fairness constraints in in-processing methods, it is not known to have been used in a pre-processing setting.

FairWASP Optimization Problem: In an exemplary embodiment, FairWASP which casts dataset pre-processing as an optimization problem that aims at minimizing the distance to the original data distribution while satisfying fairness constraints.

Given a dataset Z={(Dᵢ, Xᵢ, Yᵢ)}ᵢ₌₁ⁿ, the reweighted distribution of the dataset may be written as:

$${p}_{Z ; θ} {=}^{def .} \frac{1}{n} {\sum }_{i = 1}^{n} {θ}_{i} {δ}_{{Z}_{i}} ,$$

with {θᵢ}_{i∈[n]} such that Σᵢθᵢ=n, and Dirac measures δ_{Z}_{ᵢ} centered on Zᵢ. Here [n]={1, 2, . . . , n}. Note that the empirical distribution of the original dataset can be written in the form above by setting θᵢ=eᵢ=1 for any i, i.e.,

$${p}_{Z ; e} = \frac{1}{n} {\sum }_{i = 1}^{n} {e}_{i} {δ}_{{Z}_{i}} .$$

Use of e is then made to represent the vector with all entries being 1. In an exemplary embodiment, the Wasserstein distance between p_{Z; θ} and p_{Z; e} is used to measure the discrepancy between the original and reweighted datasets. To control for discrimination, fairness constraints which are equivalent to imposing demographic parity over the original set are utilized. In this formulation, this translates to requiring the conditional distribution under the weights {θᵢ}_{i∈[n]} to closely align with a target distribution p_{γτ} for all possible values of D,

$$J ( {p}_{Z ; θ} ( Y = y \vert D = d ) , {p}_{{Y}_{T}} ( y ) ) \leq ϵ , ∀ d ∈ D , y ∈ Y , \qquad ( Expression 2 )$$

where J(·,·) denotes a distance function between distributions. Use is made of the shorthand p_{Z; θ}(y|d) for p_{Z; θ}(Y=y|D=d). This definition corresponds to the enforcing demographic parity by constraining the selection rates across groups D=d to be equal to the overall selection rate. However, unlike a previous definition of J(p,q) as

$$\vert \frac{p}{q} - 1 \vert ,$$

in an exemplary embodiment, J is defined as the subsequent symmetric probability ratio measure:

$$J ( p , q ) = max \{ \frac{p}{q} - 1 , \frac{q}{p} - 1 \} . \qquad ( Expression 3 )$$

This definition is viewed as being more practical and theoretically sound because it is symmetric with respect to p and q and the two definitions are also equivalent when p>q and similar when p is not much smaller than q.

In an exemplary embodiment, FairWASP finds integer weights {θᵢ}_{i∈[n]} via solving the following optimization problem:

$${min}_{θ ∈ {I}^{n} ⋂ {Δ}_{n}} Wc ( pZ ; θ , pZ ; e ) \qquad ( Expression 4 )$$

$$s . t . J ( {p}_{Z ; θ} ( y \vert d ) , {p}_{YT} ( y ) ) \leq ϵ , ∀ d ∈ D , y ∈ Y$$

where Iⁿ is the set of integer vectors in Rⁿ, and Δₙ is the set of valid weights {θ∈ [symbol] ₊ⁿ:Σᵢ₌₁ⁿθᵢ=n}. The use of integer weights can be understood simply as duplicating or eliminating samples in the original datasets. This is in contrast with other approaches in which the sample-level weights are real-valued. The problem of solving the optimal real-valued weights is instead as follows:

$${min}_{θ ∈ {Δ}_{n}} {𝒲}_{c} ( {p}_{Z ; θ} , {p}_{Z ; e} ) \qquad ( Expression 5 )$$

$$such that J ( {p}_{Z ; θ} ( y \vert d ) , {p}_{YT} ( y ) ) \leq ϵ , ∀ d ∈ D , y ∈ Y .$$

Note that Expression 5 is in fact an LP relaxation of Expression 4. In practice, using real-valued weights requires either (1) resampling each sample proportionally to its weight, which does introduce statistical noise in the reweighted distribution, or (2) the inclusion of sample-weights in the loss function during the learning process. Using integer weights, however, ensures that the constructed dataset has exactly the optimal reweighted distribution and it can be fed into any classification method, not just methods which accept sample weights. In addition, Theorem 3 and Lemma 4, described below, show that using integer weights achieves the optimal value of the objective in the optimization problem for real-valued weights, i.e., the optimal solution of Expression 4 is also an optimal solution for Expression 5.

Reformulations of the Optimization Problem: In an exemplary embodiment, equivalent formulations of Expression 4 are examined. In Step 1, Expression 4 is reformulated as a mixed-integer program (MIP). However, directly solving this problem is unfeasible due to its scale. In Step 2, it is demonstrated that, through specific reformulations, the dual of the LP relaxation becomes more computationally manageable. In Step 3, it is proven that the solution of such a dual problem can lead to an optimal solution of Expression 4.

Step 1—Reformulating Expression 4 as a MIP: Firstly, it is shown that the constraint of Expression 2 can be reformulated as linear constraints on θ of the form Aθ≥0. The conditional probability in the constraint of Expression 2) can be rewritten as:

$${p}_{Z ; θ} ( y \vert d ) = \frac{{\sum }_{i ∈ [ n ] : {d}_{i} = d , {y}_{i} = y} {θ}_{i}}{{\sum }_{i ∈ [ n ] : {d}_{i} = d} {θ}_{i}} .$$

By substituting the definition of the distance J(·,·) from (3), the fairness constraints equivalently become linear constraints on {θᵢ}ᵢ₌₁ⁿ via inverting a fractional linear transformation, taking the following form for all d∈D, y∈Y:

$${\sum }_{i ∈ [ n ] : {d}_{i} = d , {y}_{i} = y} {θ}_{i} \leq ( 1 + ϵ ) \cdot {p}_{{Y}_{T}} ( y ) \cdot {\sum }_{i ∈ [ n ] : {d}_{i} = d} {θ}_{i} , \qquad ( 6 )$$

$${\sum }_{i ∈ [ n ] : {d}_{i} = d , {y}_{i} = y} {θ}_{i} \geq \frac{1}{1 + ϵ} \cdot {p}_{{Y}_{T}} ( y ) \cdot {\sum }_{i ∈ [ n ] : {d}_{i} = d} {θ}_{i} .$$

In total, Expression 6 defines 2|Y∥D| linear constraints on θ in the format of Δθ≥0, where A is a 2|Y∥D|-row matrix. It is further noted that when Y is binary, e.g., Y={0,1}, half of the linear constraints induced by Expression 2 are redundant and can be removed.

Regarding the objective, the Wasserstein distance can be equivalently formulated as a linear program with n² variables. Let′ C∈R^{n×n} represent the matrix formed by the transportation costs, i.e., Cᵢⱼ=c(zᵢ,zⱼ). Then, according to the definition of Expression 1, the objective function W_{c}(p_{Z; θ},p_{Z; e}) is given by the optimal objective of the following problem:

$${min}_{{P}^{∈} Rn \times n} 〈 C , P 〉 s . t . Pe {=}^{e , {P}_{T}} e = θ , P \geq {0}_{n \times n} \qquad ( Expression 7 )$$

where [symbol] ·,· [symbol] is the Frobenius inner product and e=1 is the vector of ones. Hence, the integer-weight optimization problem in Expression 4 is equivalent to the following MIP:

$${min 〈 C , P 〉}_{θ ∈ Rn , P ∈ R n \times n} \qquad ( Expression 8 )$$

$$such that Pe = e , {P}^{T} e = θ , P \geq {0}_{n \times n}$$

$$θ ∈ {I}^{n} ⋂ {Δ}_{n} , A θ \geq 0$$

Similarly, the real-valued weights problem in Expression 5 is equivalent to the following LP:

$${min 〈 C , P 〉}_{θ ∈ Rn , P ∈ R n \times n} \qquad ( Expression 9 )$$

$$such that Pe = e , {P}^{T} e = θ , P \geq {0}_{n \times n}$$

$$θ ∈ {Δ}_{n} , A θ \geq 0$$

It is noted that Expression 9 is actually also the LP relaxation of Expression 8. However, this reformulation is not yet practically useful, as the problem of Expression 9 involves a O(n²) number of variables, which poses a challenge for both conventional LP algorithms and state-of-the-art MIP methods, such as the LP based branch and-bound methods.

Step 2—Dual Problem of the LP Relaxation: In an exemplary embodiment, a solution of the LP relaxation of Expression 9 is proposed by considering its dual problem.

Firstly, it is noted that some constraints are currently redundant. For any feasible (θ,P), θ already lies in Δₙ; given a feasible P, this yields the following: (i) θ=P^{τ}e, (ii) e^{τ}e=n and (iii) Pe=e, so it follows that θ^{τ}e=e^{τ}Pe=e^{τ}e=n. Consequently, θ can be replaced with Pe and Expression 9 can then be reformulated equivalently as:

$${min}_{n \times n} 〈 C , P 〉 s . t . Pe = e , P \geq {0}_{n \times n} , A {P}^{T} e \geq 0 \cdot {( P )}_{P ∈ R}$$

Therefore, the optimal θ* of Expression 9 can be can be reconstructed from the optimal P* of (P) using θ*=(P*)^{τ}e.

Secondly, advantageous use is made of the property of LP problems to reformulate (P). When the feasible set of the LP problem (P) is nonempty and the optimal solution P* exists, P* is part of a saddle point of the saddle-point problem on the Lagrangian,

$${min}_{P ∈ {S}_{n}} {max}_{λ ∈ {ℝ}_{†}^{m}} L ( P , λ ) {=}^{def .} 〈 C , P 〉 - {λ}^{T} {AP}^{T} e \qquad ( PD )$$

where Sₙ={P∈R^{n×n}: Pe=e, P≥0^{n×n}}. Since L(·,·) is bilinear, the minimax theorem guarantees that (PD) is equivalent to max_{λ∈} [symbol] _{₊}_{^{m}}min_{P∈S}_{ₙ} L(P,λ). This is then equal to the dual:

$${max}_{λ \geq 0} F ( λ ) {=}^{def .} {max}_{P ∈ {S}_{n}} 〈 \overline{C} , P 〉 - F ( λ ) , \qquad ( D )$$

where C̅=Σⱼ₌₁^{m}λⱼeaⱼ^{T}−C and aⱼ^{T} is the j-th row of A.

Unlike the optimization problem in Expression 9, the dual problem (D) can be directly solved, as shown in Lemma 1 below.

Lemma 1. For function G(C̅)^{def.}=max_{P∈S}_{ₙ} [symbol] C̅,P [symbol] , it is a convex function of C̅ in R^{n×n}. It has the following function value and subgradient. For each i∈[n], let c̅ᵢⱼ_{ᵢ}_{^{*}} denote a largest component on the i-th row of C̅, then G(C̅)=Σᵢ₌₁ⁿcᵢⱼ_{ᵢ}_{^{*}}. Define components of of P*∈R^{n×n} as

$${p}_{ij} = \{ \begin{matrix}0 , & if j \neq {j}_{i}^{*} \\ 1 , & if j = {j}_{i}^{*}\end{matrix} \qquad ( Expression 10 )$$

and then P*∈arg max_{P∈S}_{ₙ} [symbol] C̅,P [symbol] and P*∈∂G(C̅).

Proof Sketch: The proof directly uses the convexity of the maximum LP's optimal objective on the cost function. The problem can be divided into independent separate smaller LP on simplexes, each having a closed-form maximizer.

Due to the chain rule, Lemma 1 shows that F(λ) is convex and the function values and subgradients of F(λ)=G(Σⱼ₌₁^{m}λⱼeaⱼ^{T}−C) can be accessible as well. This implies (D) is equivalent to

$${min}_{λ ∈ {ℝ}_{†}^{m}} F ( λ ) , \qquad ( D - 2 )$$

whose objective function F(·) is a convex function of λ (see Lemma 1). Here m is the number of rows in matrix A, which as shown above is at most 2|Y∥D|<<n. Reformulation (D-2) is important as it makes the usage of methods that require only subgradient of the dual problem (D) possible, such as the subgradient descent method and the cutting plane method (Nesterov 2018).

Finally, consideration is given to the implications for the uniqueness of the primal optimal solution P*.

Assumption 1. The problem max_{P∈S}_{ₙ} [symbol] C−Σⱼ₌₁^{m}λⱼ*eaⱼ^{T},P [symbol] has a unique maximizer for the optimal solution λ* for (D).

Corollary 2. Under Assumption 1, the primal optimal solution P* given by Lemma 1 is the unique maximizer of max_{P∈S}_{ₙ} [symbol] C̅,P [symbol] .

Proof. Once the optimal λ* of (D) is computed, using Assumption 1, the optimal solution P* of (P) then lies in arg min_{P∈S}_{ₙ}L(P,λ*), or equivalently argmax

$$P ∈ {S}_{n} 〈 {\sum }_{j = 1}^{m} {λ}_{j}^{⋆} {ea}_{j}^{T} - C , P 〉 .$$

Assumption 1 ensures there are no ties when calculating the row-wise maximum in the C̅ matrix. This holds up to a set of measure zero, as the set of C̅ such that max_{P∈S}_{ₙ} [symbol] C̅,P [symbol] has multiple maximizers is the C̅ with a row containing two or more largest components, which is of a strictly smaller dimension than the full space and thus zero measure. In practice, Assumption 1 holds almost always due to the rounding errors and termination tolerance when computing the optimal solution λ*.

Step 3—Using the Dual Solution to Solve the Original MIP: In an exemplary embodiment, it is shown how to recover the optimal P* and θ* of Expression 9 given the optimal solution λ* of (D). The following theorem demonstrates that the optimal solution (θ*,P*) of the LP of Expression 9 recovered in this manner is also optimal for the MIP of Expression 8.

Theorem 3. Let λ* be an optimal dual solution of (D) and Assumption 1 hold. P* is an optimal primal solution obtained through Lemma 1 using the form of Expression 10. Then it holds that θ*=(P*)^{τ}e and P* are optimal solutions for both the LP of Expression 9 and the MIP of Expression 8.

Proof Sketch. The proof uses the fact that the problems of Expression 9 and Expression 8 have the same objective function while the feasible set of Expression 8 is smaller than that of Expression 9, so if an optimal solution of Expression 9 is also feasible for Expression 8, then it is optimal for Expression 8 as well.

Theorem 3 shows that once Expression 9 is solved by the dual problem (D), then Expression 8 could be solved immediately. Finally, it is then possible to conclude that the solutions found by FairWASP are optimal even among real-valued weights.

Lemma 4. When Assumption 1 holds, the optimal integer weight solution of Expression 4 is as good as the optimal real-valued weight solution of Expression 5.

Cutting Plane Method for the Reformulated Problem: The cutting plane method refers to a class of methods for convex problems in settings where the separation oracle is accessible. For any λ∈R^{m} in problem (D-2), a separation oracle is a mathematical operator that returns a vector g such that g^{τ}λ≥g^{τ}λ* for any λ*∈Λ*, where Λ* denotes the set of optimal solutions for (D-2). The cutting plane method iteratively makes use of the separation oracle to restrict the feasible sets until convergence. In an exemplary embodiment, convergence is achieved when the gap between the primal problem and the dual problem is lower than a given tolerance. Algorithm 1 shows a pseudo-code breakdown of the cutting plane algorithm; variants of the cutting plane methods algorithm differ by the implementation of lines 3 and 5.

Algorithm 1: General Cutting Plane Method for (D-2)

Line 1: Choose a bounded set E₀ containing an optimal solution
Line 2: for k from 0 to n do
Line 3: Choose λ^{k} from Eₖ
Line 4: Compute g ∈ R^{m} such that g^{T}λ^{k} ≥ g^{T}λ*for any λ* ∈ Λ*
Line 5: Choose Eₖ₊₁ ⊇ {λ ∈ Eₖ:g^{T}λ ≤ g^{T}λ^{k}}
Line 6: end for

For the problem (D-2), computing separation oracles has the same complexity as computing subgradients of the main objective, which can be done efficiently. Corollary 5 below provides an analysis of both time and space complexity.

Corollary 5. With efficient computation and space management, the cutting plane method is able to solve the problem (D-2) within Õ⁴(n²+| [symbol] |²|γ|²n·log(R/ε)) flops and O(n|D∥Y|) space.

Extension to Group-Wise Demographic Parity: Equivalent notions of demographic parity can also be expressed in the same form as Expression 2. In particular, it is possible to enforce group-wise demographic parity by constraining the selection rates to be equal across group D=d with the following constraint set:

$$J ( {p}_{Z ; θ} ( y \vert {d}_{1} ) , {p}_{Z ; θ} ( y \vert {d}_{2} ) ) \leq ϵ , ∀ {d}_{1} , {d}_{2} ∈ D , y ∈ Y , \qquad ( Expression 11 )$$

which modifies the optimization problem in Expression 4 into:

$${min}_{θ ∈ {I}^{n} ∩ {Δ}_{n}} {W}_{c} ( {p}_{Z ; θ} , {p}_{Z ; e} ) \qquad ( Expression 12 )$$

$$such that J ( {p}_{Z ; θ} ( y \vert {d}_{1} ) , {p}_{Z ; θ} ( y \vert {d}_{2} ) ) \leq ϵ , ∀ {d}_{1} , {d}_{2} ∈ D , y ∈ Y .$$

In an exemplary embodiment, FairWASP may be extended to provide for group-wise demographic parity, and this is referred to herein as FairWASP-GW, which extends FairWASP to the constraints of Expression 11. It may be shown how to solve Expression 12 by (i) pointing out a connection between the constraints of Expression 2 and the constraints of Expression 11); (ii) reformulating the problem of Expression 12 and connecting it to the problem of Expression 4; and (iii) solving Expression 12 via zero-th order optimization.

Connection between the constraints of Expression 2 and the constraints of Expression 11: For any |Y|-vector t∈[0,1]^{γ} denoting the target distribution, let Θ_{ϵ; t} denote the θ that satisfies the fairness constraint of Expression 2:

$${Θ}_{ϵ ; t} {=}^{def .} \{ θ ∈ {Δ}_{n} : J ( {p}_{Z ; θ} ( y \vert d ) , {t}_{y} ) \leq ϵ , ∀ d ∈ D , y ∈ Y \} . \qquad ( Expression 13 )$$

Hence, the feasible sets of Expression 4 under the constraint of Expression 2) is Iⁿ∩Θ_{ϵ; t}_{^{−}}, where t⁻_{y}=p_{T}(y). As for the feasible set of the problem of Expression 12 under the constraint of Expression 11, define

$${Θ}_{ϵ} {=}^{def .} \{ θ ∈ {Δ}_{n} : \begin{matrix}J ( {p}_{Z ; θ} ( y \vert {d}_{1} ) , {p}_{Z ; θ} ( y \vert {d}_{2} ) ) \leq ϵ , \\ ∀ {d}_{1} , {d}_{2} ∈ 𝒟 , y ∈ 𝒴\end{matrix} \} , \qquad ( 14 )$$

obtaining Iⁿ∩Θ_{ϵ} as the corresponding feasible set.

The following lemma shows how the feasible set for the problem of Expression 4 is a subset of the problem of Expression 12's feasible set. More specifically, Θ_{ϵ} is equal to the union of Θ_{ϵ}_{^{−}}_{; t}_{^{−}} for all t⁻∈[0,1]^{Y} and a certain ϵ⁻.

Lemma 6. Let Θ_{ϵ; t} and Θ_{ϵ} be defined as in Expression 13 and Expression 14, then it holds that for any ϵ∈[0,1), Θ_{ϵ}=U_{t∈[0,1]Y}Θ_{ϵ}_{^{−}}_{; t}, in which ϵ⁻=\sqrt{1+ϵ}−1. Proof Sketch. Inclusion from both sides can be shown via constructing an element of each set respectively.

Note that Θ_{ϵ} is not convex, as the union of convex sets is not necessarily convex, making the problem of Expression 12 not convex.

Reformulation of the Problem of Expression 12: Using Lemma 6, the problem of Expression 12 may be rewritten as:

$${min}_{θ ∈ {ℝ}^{n} , t ∈ {[ 0 , 1 ]}^{y}} {W}_{c} ( {p}_{Z ; θ} , {p}_{Z ; e} ) such that θ ∈ {I}_{n} ⋂ {Θ}_{{ϵ}^{-} ; t} . \qquad ( Expression 16 )$$

which is in turn equivalent to the following problem that simultaneously optimizes over t:

$${{min}_{n}}_{θ ∈ R} {W}_{c} ( {p}_{Z ; θ} , {p}_{Z ; e} ) such that θ ∈ {I}_{n} ⋂ ( {⋃}_{t ∈ [ 0 , 1 ] Y} {Θ}_{{ϵ}^{-} ; t} ) , \qquad ( Expression 15 )$$

Compared with the problem of Expression 4, the problem of Expression 16 has t as part of the decision variables with p_{T}(y)=t and ϵ=⁻ϵ. In other words, if H_{I}(t; ⁻ϵ) is denoted as the optimal objective values for the MIP in Expression 4, then Expression 16 is equal to:

$${min}_{t ∈ {[ 0 , 1 ]}^{y}} {H}_{I} ( t ; \overline{ϵ} ) . \qquad ( Expression 17 )$$

Once the optimal t* of Expression 17 is obtained, fixing t=t* in Expression 16 and optimizing over θ yields the optimal weights θ*.

Zero-th Order Optimization Methods for Expression 17: In an exemplary embodiment, zero-th order optimization methods are employed for the minimization problem in Expression 17. This is a particularly efficient choice for at least the following two reasons. First, the value of H_{I}(t; ⁻ϵ) can be computed via the dual problem (D), as described above. Since the cost matrix remains unchanged, after solving (D) for the first time, the complexity of solving the problem again with any different t is only O\tilde{ } (n|Y|²|D|² log (R/ε)). Second, the problem in Expression 17 is of dimension |Y|, so low-dimensional, with only unit box constraints.

It is noted that many zeroth-order optimization methods have shown fast convergence to stationary points for very-low-dimension problems in practice, such as the multi-dimension golden search method and the Nelder-Mead method. In an exemplary embodiment, the Nelder-Mead method is employed.

Optimality of Integer Weights: It is noted that that once the optimal t* of Expression 17 is obtained, the problem of Expression 16 with t fixed as t*is a problem of Expression 4 with p_{T}(y)=t* and ϵ=⁻ϵ. Hence, according to Theorem 3 and Lemma 4, the optimality of integer weights also carries over to the problem of Expression 12.

Accordingly, with this technology, an optimized process for pre-processing data for algorithmic fairness via optimal transport in order to reduce disparities in classification datasets without modifying the original data is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for pre-processing data for algorithmic fairness to reduce disparities in classification datasets without modifying the original data, the method being implemented by at least one processor, the method comprising:
receiving, by the at least one processor, a first dataset that includes a plurality of samples, each respective sample including a first coordinate that relates to sensitive demographic features, a second coordinate that relates to decision-making features, and a third coordinate that relates to a decision outcome that is generated by a machine learning model;
determining, by the at least one processor, a demographic parity constraint to be applied to the first dataset;
computing, by the at least one processor, a set of respective sample-level weights that correspond to each sample included in the plurality of samples, each respective sample-level weight being a positive integer; and
generating, by the at least one processor, a second dataset by applying the set of respective sample-level weights to the first dataset,
wherein the computing of the set of respective sample weights comprises minimizing a Wasserstein distance between the first dataset and a weighted version of the first dataset while satisfying the demographic parity constraint.

2. The method of claim 1, further comprising reformulating the minimizing of the Wasserstein distance as a mixed-integer program (MIP).

3. The method of claim 2, further comprising generating a linear program (LP) relaxation of the MIP.

4. The method of claim 3, further comprising generating a dual problem that corresponds to the LP relaxation.

5. The method of claim 4, further comprising solving the dual problem by using a cutting plane method.

6. The method of claim 5, further comprising using a result of the solving of the dual problem to extend the minimizing of the Wasserstein distance to account for a group-wise demographic parity.

7. The method of claim 1, wherein the machine learning model is configured to use an artificial intelligence technique for making a decision based on input data that relates to a person, and wherein the decision relates to at least one from among a consumer finance question, a health insurance question, and a hiring question.

8. The method of claim 1, wherein the sensitive demographic features include at least one from among race, gender, national origin, and disability.

9. The method of claim 1, wherein the decision-making features include at least one from among a level of education, a grade point average (GPA), and a level of income.

10. A computing apparatus for pre-processing data for algorithmic fairness to reduce disparities in classification datasets without modifying the original data, the computing apparatus comprising:
a processor;
a memory; and
a communication interface coupled to each of the processor and the memory,
wherein the processor is configured to:
receive, via the communication interface, a first dataset that includes a plurality of samples, each respective sample including a first coordinate that relates to sensitive demographic features, a second coordinate that relates to decision-making features, and a third coordinate that relates to a decision outcome that is generated by a machine learning model;
determine a demographic parity constraint to be applied to the first dataset;
compute a set of respective sample-level weights that correspond to each sample included in the plurality of samples, each respective sample-level weight being a positive integer; and
generate a second dataset by applying the set of respective sample-level weights to the first dataset,
wherein the computation of the set of respective sample weights comprises minimizing a Wasserstein distance between the first dataset and a weighted version of the first dataset while satisfying the demographic parity constraint.

11. The computing apparatus of claim 10, wherein the processor is further configured to reformulate the minimization of the Wasserstein distance as a mixed-integer program (MIP).

12. The computing apparatus of claim 11, wherein the processor is further configured to generate a linear program (LP) relaxation of the MIP.

13. The computing apparatus of claim 12, wherein the processor is further configured to generate a dual problem that corresponds to the LP relaxation.

14. The computing apparatus of claim 13, wherein the processor is further configured to solve the dual problem by using a cutting plane method.

15. The computing apparatus of claim 14, wherein the processor is further configured to use a result of the solving of the dual problem to extend the minimization of the Wasserstein distance to account for a group-wise demographic parity.

16. The computing apparatus of claim 10, wherein the machine learning model is configured to use an artificial intelligence technique for making a decision based on input data that relates to a person, and wherein the decision relates to at least one from among a consumer finance question, a health insurance question, and a hiring question.

17. The computing apparatus of claim 10, wherein the sensitive demographic features include at least one from among race, gender, national origin, and disability.

18. The computing apparatus of claim 10, wherein the decision-making features include at least one from among a level of education, a grade point average (GPA), and a level of income.

19. A non-transitory computer readable storage medium storing instructions for pre-processing data for algorithmic fairness to reduce disparities in classification datasets without modifying the original data, the storage medium comprising executable code which, when executed by a processor, causes the processor to:
receive a first dataset that includes a plurality of samples, each respective sample including a first coordinate that relates to sensitive demographic features, a second coordinate that relates to decision-making features, and a third coordinate that relates to a decision outcome that is generated by a machine learning model;
determine a demographic parity constraint to be applied to the first dataset;
compute a set of respective sample-level weights that correspond to each sample included in the plurality of samples, each respective sample-level weight being a positive integer; and
generate a second dataset by applying the set of respective sample-level weights to the first dataset,
wherein the computation of the set of respective sample weights comprises minimizing a Wasserstein distance between the first dataset and a weighted version of the first dataset while satisfying the demographic parity constraint.

20. The storage medium of claim 19, wherein when executed, the executable code further causes the processor to reformulate the minimization of the Wasserstein distance as a mixed-integer program (MIP).
